(19) United States
(12) Patent Application Publication
(10) Pub. No.: US 2026/0328247 A1
(43) Pub. Date: Oct. 22, 2026

(54) SPHERICAL ROLLER BEARING WITH A FIRST SEALING COMPRISING AT LEAST THREE SEALING LIPS

(71) Applicant: AKTIEBOLAGET SKF, GOTEBORG (SE)

(72) Inventors: Xiang ZHANG, Gothenburg (SE); Marco Erminio PANCHETTI, Torino (IT); Lars Per Stefan NEMETH, Lidköping (SE); Lars Eric Mikael STIGSJÖÖ, Angered (SE)

(21) Appl. No.: 19/476,397

(22) PCT Filed: Apr. 10, 2024
(86) PCT No.: PCT/EP2024/059661

§ 371 Date: Oct. 17, 2025

(30) Foreign Application Priority Data
Apr. 26, 2023 (IT) 102023000008049

(51) Int. Cl. F16C 33/78; F16C 19/38

(52) U.S. Cl. CPC F16C 33/7806; F16C 19/38; F16C 33/7823; F16C 2208/10

(57) ABSTRACT

A spherical roller bearing has a first sealing (10), which is located at a first axial end (12) of the spherical roller bearing and seals a space (11) between an inner ring (14) and an outer ring (16) of the spherical roller bearing and which comprises at least three sealing lips (18, 20, 22). The at least three sealing lips abut against a surface (24) of the spherical roller bearing, which has in essence the shape of a cylinder barrel. Each of the at least three sealing lips is bent in an axial direction (26) of the spherical roller bearing away from a center of mass (28) of the spherical roller bearing and in a radial direction (30) of the spherical roller bearing away from the center of mass compared to a state, in which only gravity acts on the first sealing.

### CROSS-REFERENCE TO RELATED APPLICATIONS

This application is the U.S. National Stage of International Application No. PCT/EP2024/059661 filed on Apr. 10, 2024, which claims priority to Italian patent application no. 102023000008049 filed on Apr. 26, 2023.

### TECHNICAL FIELD

The invention concerns a spherical roller bearing having a first sealing.

### BACKGROUND OF THE INVENTION

US 2003/0063824 A1 describes a spherical roller bearing having a sealing on one axial side, which comprises several sealing lips. The sealing seals a space between an inner and an outer ring of the spherical roller bearing. A few sealing lips abut against a tapered surface of an inner ring of the bearing.

CN 203477089 U discloses a ball bearing having a sealing on one axial side, which comprises three sealing lips. The sealing lips have a curvature in an axial section.

CN 207111726 U describes a ball bearing having a sealing with three sealing lips on each axial side.

### SUMMARY OF THE INVENTION

It is one non-limiting object of the present teachings to disclose techniques for improving a spherical roller bearing having a sealing, in order to seal more effectively against heavy contamination with a cost-efficient design.

In one non-limiting aspect of the present teachings, a spherical roller bearing includes a first sealing, which is located at a first axial end of the spherical roller bearing and seals a space between an inner ring and an outer ring of the spherical roller bearing and which comprises at least three sealing lips.

The at least three sealing lips abut against a surface of the spherical roller bearing, which has essentially the shape of a cylinder barrel, and each of the at least three sealing lips is bent in an axial direction of the spherical roller bearing away from a center of mass of the spherical roller bearing and in a radial direction of the spherical roller bearing away from the center of mass compared to a state, in which only gravity acts on the first sealing. Thereby surprisingly a spherical roller bearing with a sealing can be provided, which seals effectively against heavy contamination and which has a cost-efficient design. In particular, surprisingly an effective sealing against heavy contamination can be achieved when the inner ring or the outer ring undergoes movements during self-alignment of the bearing. In particular, surprisingly an enhanced bearing service life can be achieved.

In particular, the surface is part of the inner ring.

In another non-limiting aspect of the present teachings, a spherical roller bearing, in particular as described above, having a first sealing is disclosed, which is located at a first axial end of the spherical roller bearing and seals a space between an inner ring and an outer ring of the spherical roller bearing and which comprises at least three sealing lips, wherein the at least three sealing lips abut against a surface of the spherical roller bearing, which has essentially the shape of a cylinder barrel, and each of the at least three sealing lips is bent in an axial direction of the spherical roller bearing away from a center of mass of the spherical roller bearing and in a radial direction of the spherical roller bearing to the center of mass compared to a state, in which only gravity acts on the first sealing. Thereby surprisingly a spherical roller bearing with a sealing can be provided, which seals effectively against heavy contamination and which has a cost-efficient design. In particular, surprisingly an effective sealing against heavy contamination can be achieved when the inner ring or the outer ring undergoes movements during self-alignment of the bearing. In particular, surprisingly an enhanced bearing service life can be reached.

In particular, the surface is part of the outer ring.

In another non-limiting aspect of the present teachings, a spherical roller bearing, in particular as described above, having a first sealing is disclosed, which is located at a first axial end of the spherical roller bearing and seals a space between an inner ring and an outer ring of the spherical roller bearing and which comprises at least three sealing lips, wherein an elastomeric element of the first sealing comprises only such sealing lips, which seal against a surface part of the spherical roller bearing, which is located inwardly in a radial direction of the spherical roller bearing compared to the respective sealing lip, and each of the at least three sealing lips is bent in an axial direction of the spherical roller bearing away from a center of mass of the spherical roller bearing and in a radial direction of the spherical roller bearing away from the center of mass compared to a state, in which only gravity acts on the first sealing. Thereby surprisingly a spherical roller bearing with a sealing can be provided, which seals effectively against heavy contamination and which has a cost-efficient design. In particular, surprisingly an effective sealing against heavy contamination can be achieved when the inner ring or the outer ring executes movements during self-alignment of the bearing. In particular, surprisingly an enhanced bearing service life can be reached.

In a preferred embodiment, the first sealing advantageously comprises at least one metal sheet, through which a form-locking fixation of the first sealing at (to, on) the outer ring or the inner ring is realized. Thereby a simple assembly can be achieved.

In another preferred embodiment, the first sealing advantageously consists of a one-piece elastomeric element. The term “one-piece” is to be understood in particular as being produced in one single injection molding process. A simple producibility of the sealing can be achieved thereby.

In another preferred embodiment, at least one of the sealing lips advantageously consists of alkyl acrylate copolymer or hydrogenated nitrile butadiene rubber. Compliance with hygiene regulations for a contact of the sealing with food can be reached thereby.

In particular at least one of the sealing lips can consist of nitrile butadiene rubber.

Moreover, a first one of the at least three sealing lips, which is closer to the first axial end than a second of the at least three sealing lips, is preferably longer than the second sealing lip. A good compensation of self-aligning movements of parts of the spherical roller bearing through the first and the second sealing lips can be achieved thereby.

In another preferred embodiment, the second sealing lip is advantageously closer to the first axial end than a third sealing lip of the at least three sealing lips and longer than the third sealing lip. A good compensation of self-aligning movements of parts of the spherical roller bearing through the second and the third sealing lips can be achieved thereby.

In another preferred embodiment, the first sealing is advantageously fixed at (to, on) an inner side of the outer ring. Thereby no adjustment of a fixation to a housing is necessary.

Furthermore, the spherical roller bearing may comprise a second sealing, which is located at a second axial end of the spherical roller bearing and which is identical in construction with the first sealing. Further cost saving can be achieved thereby.

### BRIEF DESCRIPTION OF THE DRAWINGS

Further advantages can be seen in the following description of the drawings. Examples of embodiments of the invention are shown in the drawings. The drawings, the description and the claims contain numerous features in combination. The skilled person will expediently also consider the features individually and combine them to form useful further combinations.

FIG. 1 shows a half axial section through a spherical roller bearing according to the present teachings.

FIG. 2 shows a part of a section through a further spherical roller bearing according to the invention.

### DETAILED DESCRIPTION OF THE INVENTION

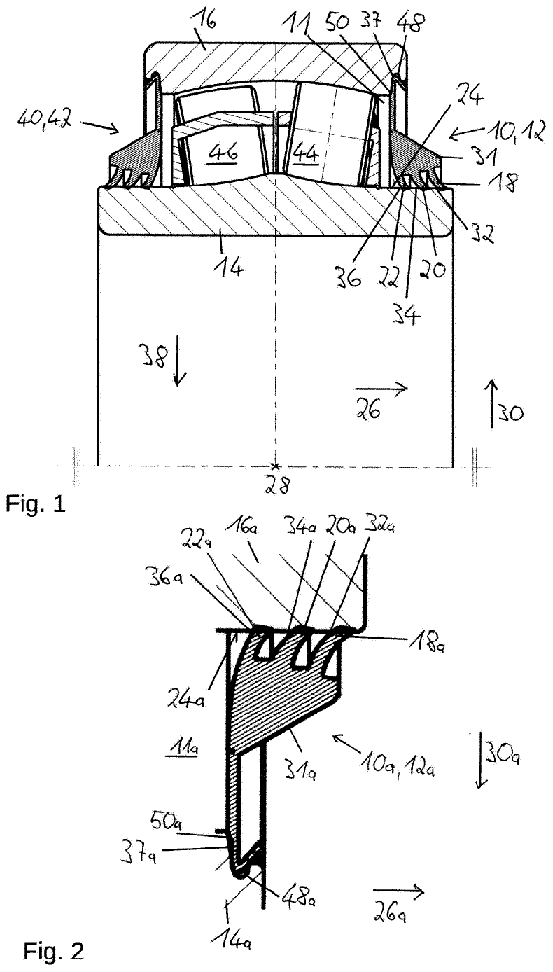

FIG. 1 shows a half section of a spherical roller bearing, which comprises an inner ring 14, an outer ring 16, a first row of rolling elements 44 and a second row of rolling elements 46 that rotatably contact a common raceway defined on the outer ring 16, the common raceway having a spherical internal shape. During operation of the spherical roller bearing, the inner ring 14 and the outer ring 16 can rotate relative to each other and the rolling elements 44, 46 move relative to the inner ring and the outer ring. A first sealing 10 of the spherical roller bearing is located at the first axial end 12 of the spherical roller bearing and seals a space 11 between the inner ring 14 and the outer ring 16. The sealing 10 comprises three sealing lips 18, 20, 22 which abut against a surface 24 of the inner ring 14. The surface 24 has the shape of a cylinder barrel (to match the cylindrical barrel shape of the rolling elements 44, 46) and can therefore be machined easily and in a very cost-efficient way. Every single one of the sealing lips 18, 20, 22 is bent in an axial direction 26 of the spherical roller bearing away from a centre of mass 28 of the spherical roller bearing and in a radial direction 30 of the spherical roller bearing away from the center of mass of the spherical roller bearing compared to a state, in which only gravity acts on the first sealing. Each one of the sealing lips is bent along its complete longitudinal extension compared to the state.

The sealing lips 18, 20, 22 are the only sealing lips of an elastomeric element (elastomeric material) 31 of the first sealing 10. The sealing lip 18 seals against surface part 32. Thereby the surface part 32 is located inwardly in a radial direction 38 of the spherical roller bearing compared to the sealing lip 18. The sealing lip 20 seals against surface part 34. For that matter the surface part 34 is located inwardly in a radial direction 38 of the spherical roller bearing compared to the sealing lip 20. The sealing lip 22 seals against surface part 36. Thereby the surface part 36 is located inwardly in a radial direction 38 of the spherical roller bearing compared to the sealing lip 22. All the surface parts 32, 34, 36 are part of the surface 24.

The first sealing 10 consists of the elastomeric element 31 and a metal sheet 37. The elastomeric element 31 is one piece. It was produced in one single injection molding process. In particular the elastomeric element 31 can consist of an alkyl acrylate copolymer, a hydrogenated nitrile butadiene rubber or a nitrile butadiene rubber. Furthermore, the elastomeric element 31 is fixed to the metal sheet 37 of the sealing 10 by vulcanization. The metal sheet 37 is fixed at (to, on) an inner side of the outer ring 16 in a form-locking way (via a snap-fit connection). That is, a radial outer circumference of the metal sheet 37 is snapped into a groove 48 on the radially inner side of the outer ring 16. The radial outer circumference of the metal sheet has a shape of a circle. A ring-shaped area 50 of the elastomeric element 31 abuts against the outer ring 16 and seals thereby an intermediate space between the metal sheet 37 and the outer ring 16.

The sealing lip 18 is closer to the first axial end 12 than the sealing lip 20 and is longer than the sealing lip 20. The sealing lip 20 is closer to the first axial end 12 than the sealing lip 22 and is longer than the sealing lip 22. If during self-alignment of the spherical roller bearing the inner ring performs (undergoes) a movement, which resembles (in the view of FIG. 1) a clockwise rotation around an axis, which intersects the center of mass 28 and is perpendicular to the axial direction 26, the sealing lips 18, 20, 22 can adjust to the new position of the inner ring 14 in an optimal way, because the surface part 32 moves a longer distance away from its original place (position) than the surface part 36.

At a second axial end 42 of the spherical roller bearing, the spherical roller bearing comprises a second sealing 40, which is identical in construction with the first sealing 10. It seals another space between the inner ring 14 and the outer ring 16.

This spherical roller bearing provides excellent sealing performance when subjected to high contamination conditions, such as in muddy environments, with an outstanding misalignment capability. In addition, spherical roller bearings have a misalignment capability which enhances the bearing fatigue life compared with other bearing solutions (designs).

In an alternative embodiment, the metal sheet 37 is bigger. In this case an axial outer side of the elastomeric element 31, except for the sealing lip 18, is scorched to the metal sheet 37.

FIG. 2 shows an alternative embodiment. Essentially identical components, features and functions are basically numbered with the same reference numerals. However, the letter “a” has been added to the reference numerals of the embodiments in FIG. 2 to distinguish them. The following description is limited, in essence, to the differences from the embodiment in FIG. 1, whereby reference can be made to the description of the embodiment in FIG. 1 with regard to components, features and functions that remain the same.

FIG. 2 shows a part of a section through an alternative embodiment of a spherical roller bearing according to the present teachings. A first sealing 10a, which is located at a first axial end 12a of the spherical roller bearing, seals a space 11a between an inner ring 14a and an outer ring 16a of the spherical roller bearing. The sealing 10a comprises three sealing lips 18a, 20a, 22a, which abut against a surface 24a of the spherical roller bearing, which has the shape of a cylinder barrel. Each of the three sealing lips is bent in an axial direction 26a of the spherical roller bearing away from a center of mass (not shown) of the spherical roller bearing and in a radial direction 30a of the spherical roller bearing to the center of mass compared to a state, in which only gravity acts on the first sealing.

1. A spherical roller bearing comprising:
an inner ring,
an outer ring, and
a first sealing located at a first axial end of the spherical roller bearing and sealing a space between the inner ring and the outer ring, the first sealing having at least three sealing lips,
wherein:
the at least three sealing lips abut against a surface of the inner ring or the outer ring, which has the shape of a cylinder barrel in axial cross-section, and
each of the at least three sealing lips is bent in an axial direction of the spherical roller bearing away from a center of mass of the spherical roller bearing and in a radial direction of the spherical roller bearing away from the center of mass compared to a state, in which only gravity acts on the first sealing.

2. (canceled)

3. The spherical roller bearing according to claim 1 wherein:
an elastomeric element of the first sealing comprises only the at least three sealing lips, which seal against a surface part of the inner ring or the outer ring, which is located radially inwardly compared to the at least three sealing lips, and
each of the at least three sealing lips is bent in the axial direction of the spherical roller bearing away from the center of mass of the spherical roller bearing and in the radial direction of the spherical roller bearing away from the center of mass compared to a state, in which only gravity acts on the first sealing.

4. The spherical roller bearing according to claim 1, wherein the first sealing comprises at least one metal sheet, through which a form-locking fixation of the first sealing at the outer ring or the inner ring is realized.

5. The spherical roller bearing according to claim 1, wherein the first sealing consists of a one-piece elastomeric element and a metal sheet.

6. The spherical roller bearing according to claim 1, wherein at least one of the at least three sealing lips consists of an alkyl acrylate copolymer, a hydrogenated nitrile butadiene rubber or a nitrile butadiene rubber.

7. The spherical roller bearing according to claim 1, wherein a first one of the at least three sealing lips, which is closer to the first axial end than a second one of the at least three sealing lips, is longer than the second one of the at least three sealing lips.

8. The spherical roller bearing according to claim 7, wherein the second one of the at least three sealing lips is closer to the first axial end than a third one of the at least three sealing lips and is longer than the third one.

9. The spherical roller bearing according to claim 1, wherein the first sealing is fixed at an inner side of the outer ring.

10. The spherical roller bearing according to claim 1, further comprising:
a second sealing located at a second axial end of the spherical roller bearing, the second sealing being identical in construction with the first sealing.

11. The spherical roller bearing according to claim 1, further comprising:
first and second rows of rolling elements disposed between the inner ring and the outer ring;
wherein the first and second rows of rolling elements rotatably contact a common raceway defined on the outer ring, the common raceway having a spherical internal shape.

12. The spherical roller bearing according to claim 11, wherein the rolling elements each have a cylindrical barrel shape in axial cross-section.

13. The spherical roller bearing according to claim 12, wherein:
the at least three sealing lips are composed of an elastomeric material that seals against a surface part of the inner ring that is located radially inwardly of the at least three sealing lips, and
each of the at least three sealing lips is bent in the axial direction of the spherical roller bearing away from the center of mass of the spherical roller bearing and in the radial direction of the spherical roller bearing away from the center of mass compared to a state, in which only gravity acts on the first sealing.

14. The spherical roller bearing according to claim 13, wherein the first sealing comprises at least one metal sheet that is affixed to the outer ring via a snap-fit connection.

15. The spherical roller bearing according to claim 14, wherein the first sealing consists of only the elastomeric material, which is one-piece, and the metal sheet.

16. The spherical roller bearing according to claim 15, wherein the elastomeric material consists of an alkyl acrylate copolymer, a hydrogenated nitrile butadiene rubber or a nitrile butadiene rubber.

17. The spherical roller bearing according to claim 15, wherein:
a first one of the at least three sealing lips is closer to the first axial end than a second one of the at least three sealing lips, and
the first one is longer than the second one.

18. The spherical roller bearing according to claim 17, wherein:
the second one of the at least three sealing lips is closer to the first axial end than a third one of the at least three sealing lips of the at least three sealing lips, and
the second one is longer than the third one.

19. The spherical roller bearing according to claim 18, wherein the first sealing is affixed to a radially inner side of the outer ring.

20. The spherical roller bearing according to claim 19, further comprising:
a second sealing located at a second axial end of the spherical roller bearing, the second sealing being identical in construction with the first sealing.

21. The spherical roller bearing according to claim 20, wherein the elastomeric material consists of an alkyl acrylate copolymer, a hydrogenated nitrile butadiene rubber or a nitrile butadiene rubber.
